(19) United States
(12) Patent Application Publication
(10) Pub. No.: US 2013/0259439 A1
(43) Pub. Date: Oct. 3, 2013

(54) OPTICAL DEVICE

(71) Applicant: SUMITOMO ELECTRIC DEVICE INNOVATIONS, INC., Yokohama-shi (JP)

(72) Inventors: Takashi Asaba, Yokohama-shi (JP); Ryo Kuwahara, Yokohama-shi (JP); Taketo Kawano, Yokohama-shi (JP)

(73) Assignee: SUMITOMO ELECTRIC DEVICE INNOVATIONS, INC., Yokohama-shi (JP)

(21) Appl. No.: 13/853,199

(22) Filed: Mar. 29, 2013

(30) Foreign Application Priority Data
Mar. 30, 2012 (JP) 2012-080785

(51) Int. Cl. G02B 6/32

(52) U.S. Cl. CPC G02B 6/32
USPC 385/140

(57) ABSTRACT

An optical device includes: a first lens; a second lens that is arranged behind a focal point of the first lens and is optically connected to the first lens; an optical attenuator that is arranged on an optical path between the first lens and the second lens and changes passage amount of an inputting light.

### CROSS-REFERENCE TO RELATED APPLICATION

This application is based upon and claims the benefit of priority of the prior Japanese Patent Applications No. 2012-080785, filed on Mar. 30, 2012, the entire contents of which are incorporated herein by reference.

### BACKGROUND

(i) Technical Field

The present invention relates to an optical device.

(ii) Related Art

Japanese Patent Application Publication No. 06-97887 discloses an optical device for transmitting and receiving an optical signal in which an optical attenuator is provided before a light-receiving element or behind a light-emitting element and intensity of an optical signal can be adjusted.

### SUMMARY

It is an object to provide an optical device that is capable of suppressing a loss of a signal and a degradation of optical return loss in an optical attenuator.

According to an aspect of the present invention, there is provided an optical device including: a first lens; a second lens that is arranged behind a focal point of the first lens and is optically connected to the first lens; an optical attenuator that is arranged on an optical path between the first lens and the second lens and changes passage amount of an inputting light.

### BRIEF DESCRIPTION OF THE DRAWINGS

FIG. 1 illustrates an overall schematic view of an optical device in accordance with a first embodiment;

FIG. 2 illustrates a block diagram of a structure of an optical detection portion and a portion behind of the optical detection portion;

FIG. 3 illustrates a structure of an optical system on a side of a signal light;

FIG. 4 illustrates a front view of a VOA;

FIG. 5 illustrates an optical device in accordance with a comparative example;

FIG. 6 illustrates a positional relation of the VOA;

FIG. 7 illustrates an angle of the VOA; and

FIG. 8 illustrates a schematic view of an optical device in accordance with a second embodiment.

### DETAILED DESCRIPTION

A light-receiving device connected to an optical fiber generally has a structure in which a front lens is a collimating lens and a rear lens is a collecting lens, in a system in which an optical signal from the optical fiber is collected by a two-sphere combining with use of two lenses. A VOA (Variable Optical Attenuator) is provided between the front lens and the rear lens as an optical attenuator for adjusting intensity of an optical signal in the above-mentioned light-receiving device. The VOA has a hole through which an optical signal passes and a shutter for covering the hole. The VOA is capable of adjusting intensity of an optical signal by adjusting an opening and closing amount of the shutter. The above-mentioned collimating lens is a lens for outputting a parallel light having a beam diameter that is the same as a diameter of the lens. Therefore, when the diameter of the hole of the VOA is smaller than the diameter of the lens, a part of the optical signal does not pass through the VOA even if the shutter of the VOA is fully opened. A loss of signal may occur, and optical return loss may be degraded.

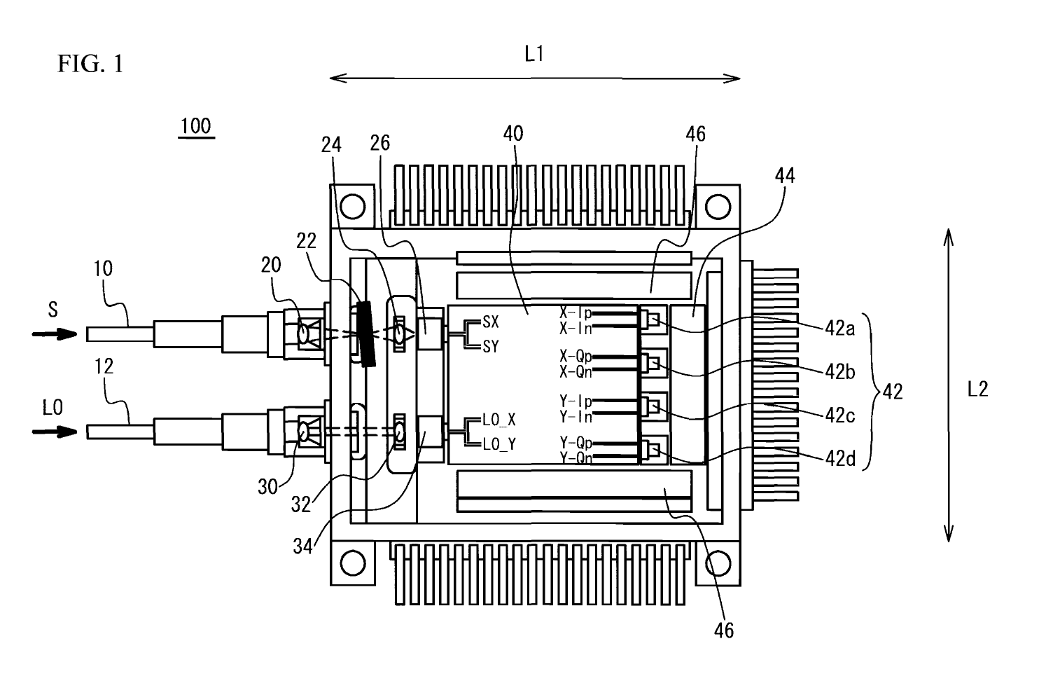

FIG. 1 illustrates an overall schematic view of an optical device in accordance with a first embodiment. In the first embodiment, a description will be given of a light-receiving device 100 acting as an optical device having a light-receiving element used in a coherent optical communication system.

As illustrated in FIG. 1, a first optical fiber 10 for inputting a signal light (S) and a second optical fiber 12 for inputting a local oscillation light (LO) are connected to the light-receiving device 100. For example, the optical fibers may be a polarization maintaining optical fiber.

In an optical system connected to the first optical fiber 10, a first lens 20, a VOA 22, a second lens 24, and a first PBS 26 are arranged in this order from the first optical fiber 10 side. The first lens 20 and the second lens 24 are a collecting lens. The VOA (Variable Optical Attenuator) 22 is an example of an optical attenuator that is capable of changing a pass amount of a light, and adjusts a light amount of a signal light reaching the second lens 24 from the first lens 20. The first PBS (Polarizing Beam Splitter) 26 disperses the signal light (S) into a polarized wave (SX) in an X-direction and a polarized wave (SY) in a Y-direction. The dispersed signal light is input into an optical hybrid 40.

In an optical system connected to the second optical fiber 12, a third lens 30, a fourth lens 32 and a second PBS 34 are arranged in this order from the second optical fiber 12 side. The second PBS 34 disperses the oscillation light (LO) having passed through the third lens 30 and the fourth lens 32 into a polarized wave (LO_X) in the X-direction and a polarized wave (LO_Y) in the Y-direction. The dispersed oscillation light is input into the optical hybrid 40.

The optical hybrid 40 is an optical circuit for delaying, dispersing and combining an input light, and is structured with a quartz-based PLC (Planar Lightwave Circuit) or the like. The signal light SX is combined with the oscillation lights LO_X and LO_Y by the optical hybrid 40. After that, the signal light SX is divided into an In-Phase component I and a Quadrature component Q, and is output as an optical signal X-Ip, an optical signal X-In, an optical signal X-Qp and an optical signal X-Qn. The signal light SY is combined with the oscillation lights LO_X and LO_Y by the optical hybrid 40. After that, the signal light SY is divided into an In-phase component I and a Quadrature component Q, and is output as an optical signal Y-Ip, an optical signal Y-In, an optical signal Y-Qp and an optical signal Y-Qn. The “p” and “n” respectively mean positive and negative. For example, the X-Ip means an output signal light of a positive component of the In-Phase component of the signal light SX.

Optical detection portions 42a to 42d including a PD (photodiode) and a TIA (trans-impedance amplifier) are provided across the first lens 20 and the second lens 24 from the optical hybrid 40. Interconnection substrates 44 and 46 are provided around the optical hybrid 40.

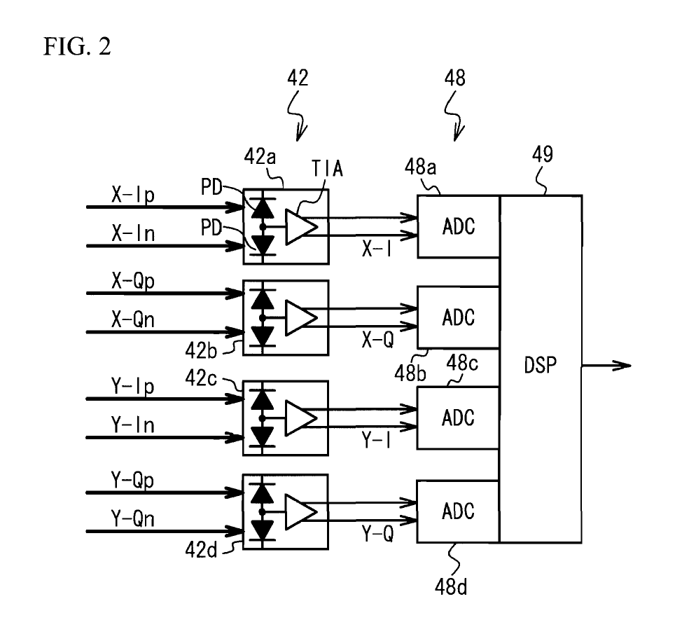

FIG. 2 illustrates a structure of the optical detection portions of the light-receiving device 100 and a circuit connected behind the light-receiving device 100. Optical signals output from the optical hybrid are respectively input into the optical detection portions 42a through 42d. Each of the optical detection portions 42a through 42d has two photo diodes PD and a trans-impedance amplifier TIA connected to the photo diodes PD. The two photo diodes PD are respectively connected optically to a plus component and a minus component of optical signals having an identical polarization direction and an identical phase component. For example, in the optical detection portion 42a, the photo diodes PD are respectively connected optically to the output signal lights X-Ip and X-In that are a positive component and a minus component of the signal light SX-I having a polarization direction X and an in-phase component I.

The trans-impedance amplifier TIA converts a combined current from the two photo diodes PD into a voltage signal and outputs the voltage signal to a rear circuit. The output signals X-I through Y-Q from the optical detection portions 42a through 42d are input into a DSP circuit 49 via rear ADC circuits 48a through 48d and are subjected to a predetermined signal processing such as demodulation. It is therefore possible to use an optical signal received by the light-receiving device 100 as an electrical signal. The ADC circuits 48a through 48d and the DSP circuit 49 may be provided inside of the light-receiving device 100.

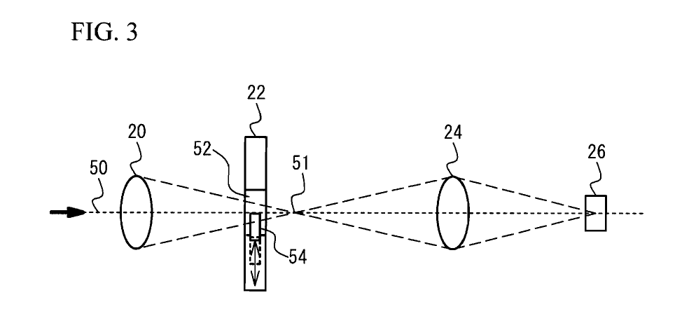

FIG. 3 illustrates a schematic view of a structure of an optical system on the side of the first optical fiber 10 for inputting the signal light S. As illustrated in FIG. 3, the second lens 24 is symmetrically arranged against the first lens 20 with respect to a focal point 51, on the same optical axis as an optical axis 50 of the first lens 20. The second lens 24 is a lens for inputting a light output from the first lens 20 into the first PBS 26. The second lens 24 has only to be arranged on a position where the second lens 24 can receive a light output from the first lens 20. It is preferable that the second lens 24 is arranged on a position illustrated in FIG. 3 in view of a transmission efficiency of an optical signal.

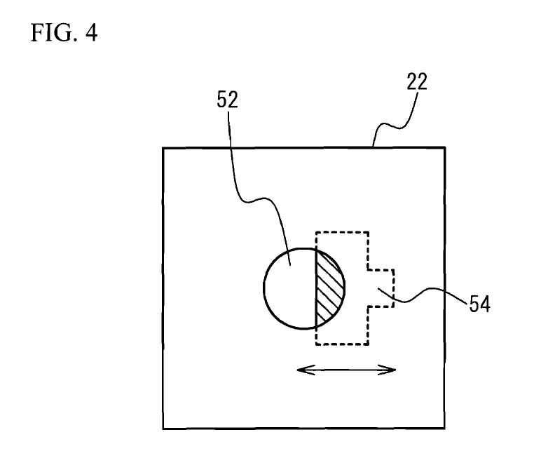

FIG. 4 illustrates a front view of the VOA 22. The VOA 22 has a hole 52 for transmitting a light and a shutter 54 for covering a part or all of the hole 52. The shutter 54 is capable of sliding along an arrow direction of FIG. 4 according to an applied voltage signal or the like, and shuts a part or all of the hole 52 (an optical path). When a size of the hole 52 is changed with use of the shutter 54, a light amount shut by the VOA 22 can be changed and a light amount input into the first PBS 26 can be changed.

When optical intensity with respect to the signal light S is not adjusted, it is preferable that the shutter 54 does not shut the optical path in order to suppress the optical loss in the VOA 22. It is necessary to arrange the VOA 22 in view of the point. A description will be given of the point in detail.

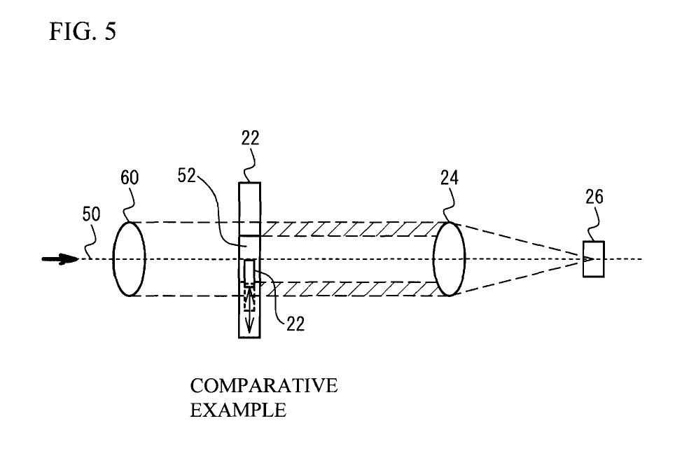

FIG. 5 illustrates a schematic view of a structure of an optical system in accordance with a comparative example with respect to FIG. 3. In FIG. 5, a collimate lens (hereinafter referred to as a fifth lens 60) is used instead of the first lens 20 for collecting of FIG. 3. The collimate lens is a lens for outputting a parallel light having a beam diameter that is the same as a diameter of the lens. The collimate lens is generally used in a coherent optical communication system in a case where an optical fiber is combined with a light-receiving device by a two-sphere combining method. The fifth lens 60 for collimating is used in order to restrain a shifting of an optical signal input into the rear second lens 24.

The fifth lens 60 is a lens for collimating. Therefore, a beam diameter of an output light is the same as a width of the fifth lens 60. In FIG. 5, the width of the fifth lens 60 is larger than the diameter of the hole 52. Therefore, even if the shutter 54 is fully opened (the shutter 54 does not shut the hole 52 at all), a part of the optical signal (S) is shut by a wall of the VOA 22 when the optical signal (S) passes through the VOA 22. Thus, a loss of an input signal occurs, and optical return loss is degraded.

In order to solve the problem, it may be designed that a beam diameter of a light output from the fifth lens 60 is smaller than the diameter of the hole 52 of the VOA 22. In concrete, there are methods such as reducing a mode field diameter of the first optical fiber 10, reducing a distance between the first optical fiber 10 and the first lens 20, or reducing a distance between the second lens 24 and the first PBS 26. However, it is difficult to achieve above-mentioned methods in view of assembly accuracy or the like. It is difficult to suppress a loss of an optical signal in the VOA 22.

In contrast, in FIG. 3 of the first embodiment, the first lens 20 is a collecting lens. Therefore, a beam diameter of a light output from the first lens 20 gets smaller toward the focal point 51. Thus, the beam diameter of the optical signal in the VOA 22 can be reduced compared to a case where a lens for collimating is used. It is therefore possible to restrain a shutting of an optical signal by the wall of the VOA 22.

As mentioned above, in accordance with the light-receiving device 100 of the first embodiment, the second lens 24 is arranged behind the focal point 51 of the first lens 20, and the VOA 22 is arranged on an optical path from the first lens 20 to the second lens 24. It is therefore possible to effectively narrow an optical signal toward the shutter 54 of the VOA 22, that is, an operation portion for controlling a light amount of the VOA. It is therefore possible to restrain the shutting of an optical signal by the wall of the VOA 22, and to suppress the loss of a signal and the degradation of the optical return loss. The present invention does not exclude a radiation of a light toward other than the operation portion for controlling the light amount of the VOA.

As illustrated in FIG. 1, the VOA 22 is fixed to a side wall of a package. And, the first lens 20 is arranged out of the package. And, the second lens 24 is arranged inside of the package. In view of an arrangement space or a layout, it is demanded that the VOA 22 is small when the VOA 22 is arranged on the side wall of the package.

The light-receiving device 100 of the first embodiment has a structure in which a beam diameter is narrowed and is radiated into the hole 52. If the fifth lens 60 for collimating is used, high assembly accuracy is necessary in order to radiate a beam into the hole 52 effectively when a diameter of the beam is the same as that of the hole 52. On the other hand, in the first embodiment, high accuracy of a relative positional relation between the beam diameter and the hole 52 is not needed, because the beam diameter is reduced. It is easy to downsize the VOA 22 and the light-receiving device 100. For example, an interval between the first lens 20 and the second lens 24 may be 20 mm. A diameter of the hole 52 in the VOA 22 may be 1.5 mm. A module size of the light-receiving device 100 may be 40 mm×37 mm.

Next, a description will be given of a preferable position and a preferable angle of the VOA 22.

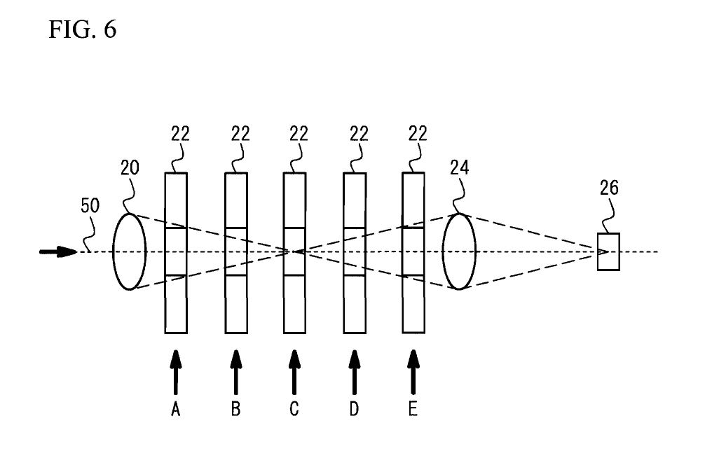

FIG. 6 illustrates a schematic view of a case where the VOA 22 is arranged at a various positions A to E. The position A is a position where the beam diameter between the first lens 20 and the focal point 51 is larger than the diameter of the hole 52. The position B is a position where the beam diameter between the first lens 20 and the focal point 51 is smaller than the diameter of the hole 52. The position C is a position on the focal point 51 of the first lens 20. The position D is a position where the beam diameter between the focal point 51 and the second lens 24 is smaller than the diameter of the hole 52. The position E is a position where the beam diameter between the focal point 51 and the second lens 24 is larger than the diameter of the hole 52. In FIG. 6, the shutter 54 is omitted.

As illustrated in FIG. 6, a part of the optical signal is shut even if the shutter 54 is fully opened, because the beam diameter is larger than the diameter of the hole 52 at the positions A and E. It is therefore preferable that the VOA 22 is arranged at a position where the beam diameter of a light output from the first lens 20 is smaller than the diameter of the hole 52.

It is difficult to adjust a light amount by opening and closing of the shutter 54, because the beam diameter is locally minimum at the focal point 51 (the position C). Therefore, it is preferable that the VOA 22 is arranged at a position other than the focal point 51. It is preferable that the VOA 22 is arranged at a position where the beam diameter is 50% or more of the hole of the VOA 22 in order to adjust the light amount of the VOA 22 accurately. It is preferable that the VOA 22 is arranged at a position where the beam diameter is 70% or more of the hole of the VOA 22.

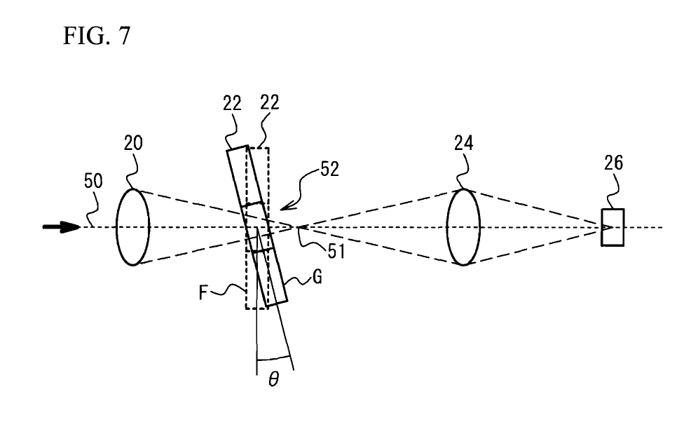

FIG. 7 illustrates a schematic view where the angle of the shutter 54 of the VOA 22 is changed (F and G). At the position F, the VOA 22 is arranged so that an incidence face of the shutter 54 is at a right angle with the optical axis 50 of the first lens 20. Actually, it is preferable that the incidence face of the shutter 54 is inclined a little with respect to the optical axis 50, as in the case of the position G. Thus, interference against the optical signal by a light reflected by the shutter 54 or the like is suppressed, and degradation of the optical signal is suppressed. The shutter 54 may be inclined with respect to not the optical axis 50 of the first lens 20 but the optical axis of the second lens 24.

Accordingly, it is preferable that the VOA 22 is arranged on the optical path between the first lens 20 and the second lens 24 other than the focal point 51 of the first lens 20 where the beam diameter is smaller than the diameter of the hole 52. It is preferable that the VOA 22 is arranged so that the incidence face of the shutter 54 is inclined by 3 to 10 degrees (for example, 5 degrees) with respect to a plane which is perpendicular to the optical axis of the first lens 20 or the second lens 24.

In the first embodiment, the method of using the shutter 54 acting mechanically is described as an adjusting method of the light passage amount with use of the VOA 22. However, the structure is not limited if a mechanism for adjusting the light passage amount is provided.

### Second Embodiment

A second embodiment is a case of an optical device having a light-emitting element.

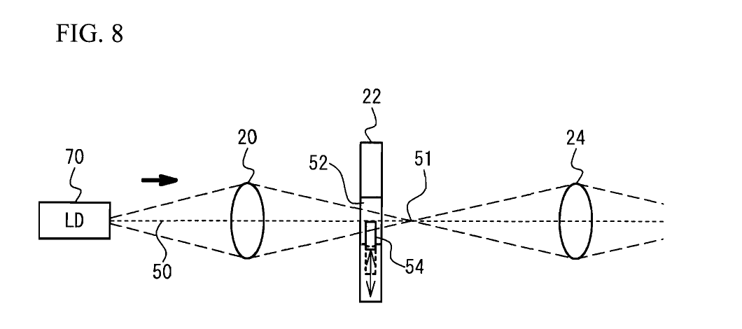

FIG. 8 illustrates a schematic view of an optical device in accordance with the second embodiment. A description will be given of a laser diode 70 as the optical device having a light-emitting element.

As illustrated in FIG. 8, the first lens 20, the VOA 22 and the second lens 24 are arranged in this order from the laser diode 70 side on the optical axis 50 of the laser diode 70. The function, the structure and the positional relation of the first lens 20, the VOA 22 and the second lens 24 are the same as the first embodiment illustrated in FIG. 3. Therefore, a detailed description is omitted. A light emitted from the laser diode 70 is collected by the first lens 20, passes through the VOA 22, is inverted at the focal point 51, and reaches the second lens 24. The VOA 22 adjusts the intensity of the optical signal by changing the opening and closing amount of the shutter 54.

In the optical device in accordance with the second embodiment, the VOA 22 is arranged between the first lens 20 and the second lens 24 acting as a collecting lens, as in the case of the first embodiment. Thus, the loss of an optical signal and the degradation of the optical return loss in the VOA 22 can be suppressed when the intensity of the optical signal emitted by the laser diode 70 is adjusted with use of the VOA 22. In the second embodiment, the laser diode 70 is used as a light-emitting element. However, another light emitter may be used as a light-emitting element other than the laser diode.

The present invention is not limited to the specifically disclosed embodiments and variations but may include other embodiments and variations without departing from the scope of the present invention.

What is claimed is:

1. An optical device comprising:
a first lens;
a second lens that is arranged behind a focal point of the first lens and is optically connected to the first lens;
an optical attenuator that is arranged on an optical path between the first lens and the second lens and changes passage amount of an inputting light.

2. The optical device as claimed in claim 1 wherein the optical attenuator has a hole and a shutter for interrupting a light passage through the hole.

3. The optical device as claimed in claim 2 wherein the hole is arranged at a position where a beam diameter of the light between the first lens and the second lens is equal to or less than a diameter of the hole of the optical attenuator.

4. The optical device as claimed in claim 2, wherein an incidence face of the shutter of the optical attenuator is inclined with respect to an optical axis of the first lens or the second lens.

5. The optical device as claimed in claim 1, wherein:
the optical attenuator is fixed to an external wall of a package housing;
the first lens is arranged outside of the external wall of the package housing; and
the second lens is arranged inside of the external wall of the package housing.

6. The optical device as claimed in claim 2, wherein:
an optical incidence face of the shutter is inclined to a plane which is perpendicular to the optical axis by 3 to 10 degrees.

7. The optical device as claimed in claim 2, wherein the hole is arranged at a position where the beam diameter of the light is 70% or more of a diameter of the hole.

8. The optical device as claimed in claim 1, further comprising an optical element optically connected with the attenuator, that includes a laser or a photodiode.

9. The optical device as claimed in claim 1, further comprising an optical hybrid receiving a signal light and a Local Oscillator light, the signal light having passed through the optical attenuator.
